(19) United States
(12) Patent Application Publication
(10) Pub. No.: US 2020/0100505 A1
(43) Pub. Date: Apr. 2, 2020

(54) MICROBIAL INSECTICIDE FOR CONTROL OF MULBERRY THRIPS

(71) Applicants: FARMHANNONG CO., LTD., Seoul (KR); INDUSTRIAL COOPERATION FOUNDATION CHONBUK NATIONAL UNIVERSITY, Jeonju-si, Jeollabuk-do (KR)

(72) Inventors: Taek-Su SHIN, Daejeon (KR); Tae-Hoon KIM, Daejeon (KR); Tae-Hyun PARK, Gwangju (KR); Pan-Jung HA, Daejeon (KR); Eul-Jai MYUNG, Anyang-si (KR); Han-Young LEE, Seoul (KR); Jae-Su KIM, Jeonju-si (KR); Se-Jin LEE, Iksan-si (KR); Jong-Cheol KIM, Iksan-si (KR); Si-Hyeon KIM, Jeonju-si (KR); Mi-Rong LEE, Wanju-gun (KR)

(73) Assignees: FARMHANNONG CO., LTD., Seoul (KR); INDUSTRIAL COOPERATION FOUNDATION CHONBUK NATIONAL UNIVERSITY, Jeonju-si, Jeollabuk-do (KR)

(21) Appl. No.: 16/500,558

(22) PCT Filed: Apr. 21, 2017
(86) PCT No.: PCT/KR2017/004264

§ 371 Date: Oct. 3, 2019

(51) Int. Cl. A01N 63/04; A01N 25/12

(52) U.S. Cl. CPC A01N 63/04; A01N 25/12

(57) ABSTRACT

The present invention relates to a microbial insecticide for control of thrips, comprising a Beauveria bassiana ERL836 strain (KCCM11506P) or a spore thereof. The insecticide of the present invention shows an insecticidal activity as potent as pre-existing chemical insecticides against thrips, is environmentally friendly, and easy to manage and produce, thus finding outstanding commercial applications.

### TECHNICAL FIELD

The present invention relates to a microbial insecticide for control of thrips.

### BACKGROUND ART

Thrips spp. is an insect that belongs to the order Thysanoptera, and is a small-sized insect pest that emerges throughout the year to cause great damage to all the crops whose flowers bloom, such as gardening and flowering plants. In particular, Western flower thrips and Melon thrips are non-native invasive insect pests that are currently spreading throughout the nation to cause serious damage to various agricultural crops. And Some viruses such as tomato spotted wilt virus (TSWV) are mediated by these insect pests. Therefore, the control of these species is especially required.

Meanwhile, the thrips is highly proliferative, and shows rapid resistance development to chemical insecticides, compared to other insect pests.

Within 1 month after thrips trespasses into any facility, thrips spends one generation and it has a variety of mixed life stages such as eggs, larvae, pupae, adults, and the like.

Therefore, the thrips is considered to be an insect pest that is relatively difficult to control using an insecticide.

For control of thrips, approximately 220 chemical insecticides such as pyriproxyfen, spinetoram, and the like have been used so far. However, the thrips has resistance to most of these chemical insecticides, and also has resistance to recently studied and developed chemical insecticides such as spinosad, acetamiprid, dinotefuran, and the like. Carbamate-based insecticides (bendiocarb, carbosulfan, methiocarb, and the like), organophosphate-based insecticides (methomyl, chlorpyrifos, diazino, and the like), synthetic pyrethroid-based insecticides (acrinathrin, bifenthrin, cyhalothrin, and the like), neonicotinoid-based insecticides (imidacloprid, acetaprid, dinotefuran, and the like), microorganism-derived biochemical agents (spinosad), mectin-based insecticides (abamectin, milbemectin, and the like), and the like have been reported as the representative chemical insecticides to which the thrips have resistance.

As there has been recently a growing interest in side effects such as environmental pollution, the advent of resistant insect pests according to the continuous use and abuse of the chemical insecticides, and the like, the use of the chemical insecticides has been gradually limited. A biological control method that may replace such chemical insecticides and is environmentally safe, has been actively studied. For example, the biological control method is a control method using natural enemies such as Orius sp., predatory mites, and the like, or using entomopathogenic fungi that infect the insect pests. Approximately 750 or more entomopathogenic fungi have been known so far. Among these, Beauveria bassiana, Metarhizium anisopliae, Nomuraea rileyi, and the like have been typically developed as the microbial insecticides, and used to control various insect pests.

With regard to the Beauveria bassiana strain, KR 10-2016-0000537 discloses the insect insecticidal activity against a beet armyworm larva by a Beauveria bassiana FG274 strain, KR 10-2016-0139521 discloses the insecticidal activity against a two-spotted spider mite or green peach aphid by a Beauveria bassiana SD15 strain, KR 10-2016-0084968 discloses the insecticidal activity against a Riptortus clavatus by a Beauveria bassiana JEF007 strain, KR 10-2011-0011239 discloses the insecticidal activity against a Monochamus alternatus or a Moechotypa diphysis by a Beauveria bassiana MaWl strain, KR 10-2011-0094749 discloses the insecticidal activity against a Monochamus saltuarius by a Beauveria bassiana MsW1 strain, and KR 10-2015-0113255 discloses the insecticidal activity against paddy rice insect pests such as Laodelphax striatellus (Fallen) or Issorhoptrus oryzophilus Kuschel by a Beauveria bassiana ERL836 strain.

However, for controlling thrips, there is still a need for new highly active microbial insecticides that can be strongly controlled, environmentally friendly, and easy to handle and use, at the same level as chemical insecticides.

### PRIOR-ART DOCUMENTS

### Patent Documents

KR 10-2016-0000537

KR 10-2016-0139521

KR 10-2016-0084968

KR 10-2011-0011239

KR 10-2011-0094749

KR 10-2015-0113255

### DISCLOSURE

### Technical Problem

During searching a potent microbial insecticide against thrips, the present inventors have found a novel microorganism, named Beauveria bassiana ERL386 strain, shows an insecticidal activity against thrips at the same level as the chemical insecticides. Therefore, the present invention has been completed based on these facts.

Also, an object of the present invention is to provide an environmentally friendly microbial insecticide which shows an excellent insecticidal activity against thrips at the same level as the conventional chemical insecticides, and also is easy to handle and use.

### Technical Solution

To solve the above problems, according to one aspect of the present invention, there is provided a microbial insecticide for control of thrips, which includes a Beauveria bassiana ERL836 strain or a spore thereof having entomopathogenicity.

According to another aspect of the present invention, there is provided a controlling method against thrips, by applying the microbial insecticide of the present invention to a habitat, a plant to be protected from the insect pest, or soil.

### Advantageous Effects

The microbial insecticide including a Beauveria bassiana ERL836 strain or a spore thereof according to the present invention shows a potent insecticidal activity against thrips at the same level as the conventional chemical insecticides.

Also, the microbial insecticide of the present invention especially shows a potent insecticidal activity against pupae of the thrips in the soil.

Also, the microbial insecticide of the present invention is environmentally friendly, and easy to handle and produce, thus providing excellent commercial applicability.

### DESCRIPTION OF DRAWINGS

FIG. 1 shows a granular preparation of a microbial insecticide according to the present invention.

FIG. 2 shows colonies of a Beauveria bassiana ERL836 strain of the present invention, which is formed in the soil after 7 days when the soil is treated with the microbial insecticide of the present invention.

FIG. 3 is an image showing that pupae of thrips in the soil come into active contact with the colonies of the Beauveria bassiana ERL836 strain of the present invention.

FIG. 4 shows the comparison of the densities of thrips between a group treated with the microbial insecticide of the present invention (Treatment Group), a group treated with a chemical insecticide (i.e., clothianidin)(Comparison Group), and a group which is not treated with any insecticide (Control Group) (a: after 20 days, b: after 40 days).

FIG. 5 shows the comparison of the densities of thrips between a group treated with the microbial insecticide of the present invention (Treated Group), a group treated with a chemical insecticide (i.e., spinetoram)(Comparison Group), and a group which is not treated with any insecticide (Control Group).

FIG. 6 shows the comparison of the densities of thrips between a group treated with the microbial insecticide of the present invention (Treated Group), a group treated with a known microbial insecticide (i.e., a Beauveria bassiana GHA strain)(Comparison Group), and a group which is not treated with any insecticide (Control Group).

### BEST MODE

The Beauveria bassiana ERL836 (KCCM11506P) strain of the present invention is isolated by the present inventors. That is, a Beauveria bassiana strain showing a remarkable insecticidal effect against paddy rice insect pests such as Laodelphax striatellus (Fallen), Nilaparvata lugens, Sogatella furcifera, Issorhoptrus oryzophilus Kuschel, is isolated by a biological assay test. The isolated strain is identified morphologically, and analyzed by a genomic DNA sequencing. Since, the isolated strain of this invention shows approximately 98% homology with Beauveria bassiana strain GHA known in the related art, the isolated strain is identified as a Beauveria bassiana strain. The isolated strain is named ‘ERL836’, and deposited in the Korean Culture Center of Microorganisms(KCCM) on Jan. 22, 2014 (Accession Number: KCCM11506P).

The Beauveria bassiana ERL836 strain of the present invention is disclosed in detail in KR 10-2015-0113255, the disclosure of which is incorporated herein by reference in its entirety. The Beauveria bassiana ERL836 strain of the present invention may be available from KCCM.

The Beauveria bassiana ERL836 strain form white colonies, has very excellent spore-forming ability and spore storage stability. That is, Beauveria bassiana ERL836 strain of this invention shows better than 2 to 3 times spore-forming ability and better than 4 to 6 times spore storage stability than the known Beauveria bassiana GHA strain.

When the Beauveria bassiana ERL836 strain of the present invention is attached to a shell of a host insect (i.e., thrips) to germinate, the microorganism of this invention produces chitinases, proteases, lipases, and/or esterases to penetrate a cuticula layer of thrips so that the microorganism of this invention invades an insect pest, and produces toxic substances while growing in the insect pest, thereby hindering an immune response of the insect pest and killing the host insect pest.

Surprisingly, it was confirmed in the present invention that the Beauveria bassiana ERL836 strain has a highly excellent insecticidal activity against thrips. Thus the Beauveria bassiana ERL836 strain may be useful in controlling various kinds of thrips, such as Western flower thrips, Melon thrips, Frankliniella intonsa, or Thrips tabaci Lindeman.

As described above, it is known that the “Beauveria bassiana ERL836 strain” of the present invention effectively kills paddy rice insect pests such as Laodelphax striatellus (Fallen), and the like. Thrips is an insect pest that generally grows in flowering plants or fruit trees whose flowers bloom and has completely different characteristics to paddy rice insect pests such as Laodelphax striatellus (Fallen), and the like. Therefore, it is very surprising to those skilled in the art that the Beauveria bassiana ERL836 strain of the present invention shows an insecticidal effect against thrips, and the insecticidal effect is not easily predicted from the insecticidal effect against the conventional paddy rice insect pests.

In the present invention, it was confirmed that the Beauveria bassiana ERL836 strain has a potent insecticidal effect against thrips. The Beauveria bassiana ERL836 strain shows an equivalent or superior insecticidal effect, compared to the chemical insecticides such as clothianidin or spinetoram, which are known to show potent insecticidal efficacy against thrips (see Examples 4 and 5). Also, the Beauveria bassiana ERL836 strain shows a highly superior insecticidal effect, compared to a previously known Beauveria bassiana strain GHA strain reported to have an insecticidal activity against thrips (see Example 6).

The spores of the Beauveria bassiana ERL836 strain according to the present invention may be produced by incubating the Beauveria bassiana ERL836 strain in a solid culture medium.

The microbial insecticide of the present invention may be provided in the form of a granular preparation, a liquid-phase preparation, or compost.

Specifically, the granular preparation refers to a solid granular form, and may be prepared by incubating the Beauveria bassiana ERL836 strain in a solid culture medium and harvesting the incubated product.

The solid culture medium may include any one selected from millet, white rice, wheat bran, Italian millet, sorghum, and a combination thereof. The solid culture medium may be mixed with an organic acid. The solid culture medium mixed with an organic acid may allowed to absorb water by immersing in water at 80 to 100° C. for 0.5 to 1.5 hours.

In the present invention, the solid culture medium is prepared by adding an organic acid such as citric acid to Italian millet, allowing the mixture to absorb water for 0.5 to 1.5 hours while being maintained at 80 to 100° C. in a water bath. And then, the immersed solid culture medium is sterilized for 10 to 40 minutes at a temperature of 110 to 130° C.

The organic acid may be used without any particular limitation. More specifically, any one selected from citric acid, propionic acid, butylic acid, lactic acid, succinic acid, gluconic acid, valeric acid, caproic acid, and a combination thereof may be used. Preferably, citric acid may be used as the organic acid. The mixing of the solid culture medium with the organic acid may be performed by adding the organic acid to the solid culture medium and mixing the solid culture medium with the organic acid.

A culture vessel generally used in the art to which the present invention belongs may be used as a culture vessel for the strain, and types of the culture vessel are not limited. For example, the culture vessel may be attached to an oxygen-supplying filter, which may smoothly supply oxygen to a polyvinyl bag, and then may be used for incubation.

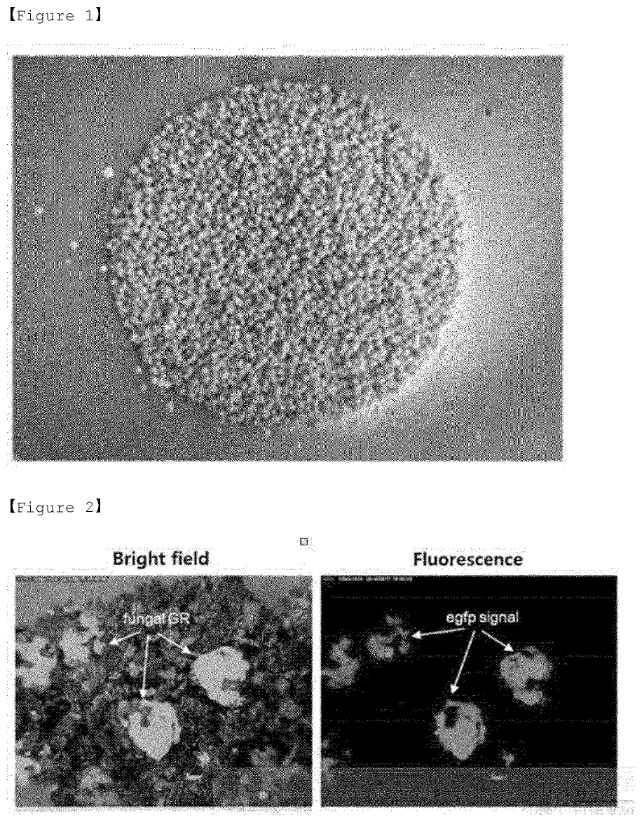

The Beauveria bassiana ERL836 strain is seeded in a prepared solid medium, and then cultured at 20 to 30° C. for 6 to 8 days. Preferably, the Beauveria bassiana ERL836 strain is cultured at 25° C. for 7 days. An inoculum which may be used in the solid culture medium may be obtained by subculturing the Beauveria bassiana ERL836 strain, and the culturing of the ERL836 strain may be performed according to a conventional subculturing method. Types of media required for the subculturing are not limited. As one example of subculture medium, a liquid medium including a potato dextrose broth (PDB) medium, rice bran, or wheat bran can be used, but types of the liquid medium are not limited. The harvested solid medium-cultured product is generally produced in the form of granules (see FIG. 1).

A liquid-phase preparation refers to a liquid form, and may be prepared by incubating the Beauveria bassiana ERL836 strain in a solid culture medium; putting the incubated product into a filterable bag; and putting the filterable bag into water to elute the Beauveria bassiana ERL836 strain or spores thereof. The filterable bag is a bag composed of water-permeable filterable material. The filterable bag is preferably formed of one or more selected from the group consisting of synthetic fibers such as polyester, nylon, polyethylene, polypropylene, and vinylon; semi-synthetic fibers such as rayon, and the like; woven or non-woven fabrics composed of single or composite fibers of natural fibers of Broussonetia kazinoki and Edgeworthia chrysantha; and mixed drafting paper and paper composed of Manila hemp, wood pulp, polypropylene fiber, and the like.

The granular preparation undergoes a production process simpler than the liquid-phase preparation, and thus may be advantageous in terms of period shortening and cost saving.

Meanwhile, because the commercially available Beauveria bassiana GHA strain, and the like are already known to be used against thrips, but insect pests in the soil are known to have resistance to that stain. So Beauveria bassiana GHA strain is generally subjected to aerial parts such as leaves, and the like (i. e. foliage treatment). On the other hand, when the granular preparation of the present invention is applied to the soil, the granular preparation showed an excellent control effect against pupae of thrips, as will be described below.

Therefore, in addition to the conventional method for treatment of the Beauveria bassiana strain (i.e., foliage treatment), the microbial insecticide as a granular formulation of the present invention is particularly applied to the soil (i. e. soil surface, mixed soil, treated soil surface, treated furrows, and the like) to kill the pupae of thrips, effectively. Also, the strain of the present invention has an advantage in that the strain may quickly form colonies in the soil to continuously show an insecticidal effect, thereby reducing repeated application of the insecticide to a minimum.

The microbial insecticide of the present invention may further include an additive available in the related art.

Also, the present invention provides a method for control of thrips, which includes applying the microbial insecticide to an insect pest, a habitat thereof, a plant to be protected from the insect pest, or soil.

Examples of suitable crops may include all types of crops whose flowers blossom, such as gardening and flowering plant, and the like, for example, Solanaceae crops such as tomato, pepper, eggplant, potato, and the like; vegetable crops such as watermelon, oriental melon, cucumber, pepper, and the like; flowering plants such as lily, carnation, chrysanthemum, gerbera rose, and the like.

The microbial insecticide of the present invention may be not only directly applied to thrips (adults, eggs, larvae, and the like) in the aerial part of the plant, but also applied to a subterranean part to control thrips (pupae) present in the soil at the same time. Thereby thrips could be controlled on the all life stages. In particular, the insecticidal microorganism (fungus) of the present invention may be applied to the soil (under the high-humidity conditions, the presence of nutrients) rather than the aerial part to easily proliferate in the soil, and may be settled down in the ecosystem in the long term. Thereby the insecticidal microorganism of the present invention may effectively control the thrips entering the soil.

The microbial insecticide including the Beauveria bassiana ERL836 strain or spores thereof according to the present invention is preferably applied at a use amount of 10⁴ to 10⁸ spore/soil g when applied to the soil. When the microbial insecticide is sprayed as a liquid-phase formulation, the microbial insecticide is preferably applied at a use amount of 10⁴ to 10⁸ spores/mL. When the microbial insecticide is used in this range, the microbial insecticide may generally show a sufficient control effect.

### MODE FOR INVENTION

Hereinafter, preferred embodiments are provided to aid in understanding the present invention. However, it should be understood that the following examples are merely intended to provide a better understanding of the present invention, and are not intended to limit the scope of the present invention.

### Example 1: Preparation of Microbial Insecticide of the Present Invention (Granular Preparation)

The Beauveria bassiana ERL836 (KCCM11506P) strain (available from the Korean Culture Center of Microorganisms) was incubated in a liquid PDB medium at room temperature for 3 days to obtain a suspension (concentration: 1×10⁷ conidia/ml). Meanwhile, 200 g of Italian millet was put into a polyvinyl bag for incubation, and 0.16 mL of 50% citric acid was added thereto. Thereafter, the Italian millet was thermally treated at 90° C. for an hour in a water bath so that the Italian millet sufficiently absorbs water, thereby to prepare a solid culture medium. In this case, oxygen was smoothly supplied through an opening of a polyvinyl bag using a paper cup and sterile gauze, and the polyvinyl bag was sterilized at 121° C. for 15 minutes and used. The prepared solid culture medium was cooled to room temperature, and 1 mL of the suspension of Beauveria bassiana ERL836 strain (1×10⁷ conidia/mL) was seeded, incubated at 25° C. for 7 days, and dried at room temperature for one day to obtain the microbial insecticide of the present invention in the form of granules (see FIG. 1).

### Example 2: Preparation of Microbial Insecticide of the Present Invention (Liquid-Phase Preparation)

10 g of the granules prepared in Example 1 were put into a filterable bag, and sealed, and 10 L of water was added thereto. Thereafter, the resulting mixture was agitated to release the strain and spores into water, thereby to prepare a liquid-phase preparation.

### Example 3: Confirmation of Soil Settlement and Contact with Thrips after Treatment of Soil with Microbial Insecticide of the Present Invention

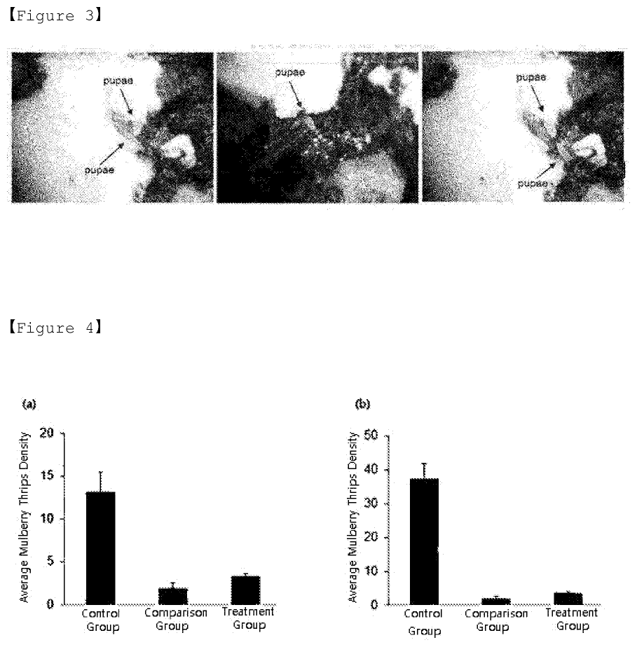

The soil was treated with 2 g of the microbial insecticide granules of the present invention obtained in Example 1, and the soil settlement of the Beauveria bassiana ERL836 strain and the contact with larvae and pupae of thrips were observed after 7 days. The results are shown in FIG. 2 and FIG. 3, respectively. From the results, it was confirmed that the Beauveria bassiana 836 strain started to grow from 3 days after the soil treatment, and was smoothly colonized in the soil (see FIG. 2). Also, the pupae of thrips present in the soil come into active contact with the strain colonies of the present invention (FIG. 3).

### Example 4: Confirmation of Insecticidal Effect Against Thrips of Microbial Insecticide of the Present Invention

An experiment on the insecticidal effect against thrips was carried out in a tomato crop. A population of the tomato crop having a height of 20 to 25 cm was used, and the tomato crop was put into a plastic cage (30×30×60 cm³) equipped with a sieve with mesh smaller than that of Western flower thrips to prevent Western flower thrips from moving from a treatment zone, and an experiment was then performed.

A pot in which a tomato crop was planted, was treated with 2 g of the microbial insecticide granules of the present invention prepared in Example 1. Also, as the comparison group, the tomato crop was treated with an agricultural chemical (i.e., clothianidin) known to show a potent insecticidal effect against thrips at an amount of 0.02 g (i.e., an amount of 3 kg/10 a) per pot, and no insecticide was applied to the pot of the control group.

TABLE 1

| | Thrips density (number/plant) | |
|---|---|---|
| | After 20 days | After 40 days |
| Untreated control group | 14.1 ± 1.7 | 38.0 ± 5.1 |
| Comparison group | 3.7 ± 0.5 | 2.4 ± 0.4 |
| Inventive insecticide treatment group | 4.3 ± 0.3 | 3.1 ± 0.6 |

As can be seen in Table 1 and FIG. 4, it was confirmed that the microbial insecticide of the present invention had a potent insecticidal effect against thrips at an equivalent level with respect to clothianidin (85 to 95%).

### Example 5: Confirmation of Insecticidal Effect of Microbial Insecticide Against Thrips of the Present Invention Under Greenhouse Conditions

An insecticidal effect of the microbial insecticide of the present invention against thrips was tested under large greenhouse conditions.

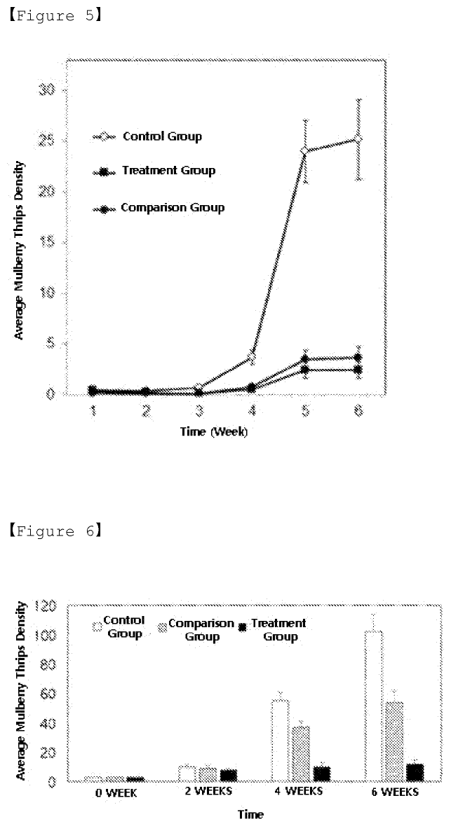

Cucumber was regularly planted in a large greenhouse, and a surface of the soil under the cucumber was treated with the insecticide granules (concentration: 10⁷ conidia/g) of the present invention prepared in Example 1 at an input amount of 3 kg/10a. As a comparison group, spinetoram WDG (concentration: 5% by weight, in the form of water-dispersible granules), which was an insecticide known to show a potent insecticidal effect against thrips, was subjected twice to foliage treatment at an input amount of 0.5 g/L. Meanwhile, the control group was not treated with any insecticide. Amounts of thrips produced in the treatment group, the comparison group, and the control group were examined with the naked eye at intervals of one week after treatment with the insecticide, and changes in densities of the populations were analyzed for 6 weeks. The results are shown in FIG. 5. In FIG. 5, the units of an average density are indicated by the number of thrips per plant.

Also, the control efficacy was calculated according to the following equation to evaluate the insecticidal efficacy.

Control Efficacy=(D_{Control}−D_{Treated})/D_{Control}×100

wherein D_{control} represents an average density of thrips in the control group which was not treated with any insecticide, and D_{Treated} represents an average density of thrips in the treatment group which was treated with the insecticide.

TABLE 2

| | Control efficacy (%) |
|---|---|
| Treatment group (ERL836) | 91.3 |
| Comparison group (spinetoram WDG- | 85.5 |
| treated group) | |

As can be seen in Table 2 and FIG. 5, it was confirmed that the microbial insecticide of the present invention had a superior insecticidal effect against thrips, compared to the spinetoram WDG.

### Example 6: Comparison Between Insecticidal Effects of ERL836 and GHA Against Thrips (Laboratory Experiment)

The insecticidal effect of the Beauveria bassiana ERL836 strain of the present invention against thrips was confirmed with respect to the conventional Beauveria bassiana GHA strain. An insecticidal experiment was performed for a chrysanthemum crop. A population of the chrysanthemum crop having a height of approximately 20 cm was used, and the chrysanthemum crop was put into a plastic cage (30×30×60 cm³) equipped with a sieve with mesh smaller than that of Western flower thrips to prevent Western flower thrips from moving from a treatment zone, and an experiment was then performed.

A pot in which a chrysanthemum crop was planted was treated with 2 g of the microbial insecticide granules of the present invention prepared in Example 1. Also, as the comparison group, the chrysanthemum was treated with 2 g of the granules obtained after the GHA strain was grown in the soil in the same manner as in Example 1 with respect to the ERL836. After a week of treatment with the insecticide, five Western flower thrips adults were released per pot in the two microorganism-treated groups and the control group (untreated), and the densities of thrips were examined at intervals of 2 weeks for 6 weeks. The results are listed in the following Table 3 and shown in FIG. 6.

TABLE 3

| | Thrips density (number/plant) | | | |
|---|---|---|---|---|
| | Right after | After | After | After |
| | treatment | 2 weeks | 4 weeks | 6 weeks |
| Untreated control | 5.0 ± 0.0 | 10.1 ± 2.5 | 55.8 ± 6.5 | 102.3 ± 12.0 |
| group | | | | |
| Comparison group | 5.0 ± 0.0 | 9.3 ± 2.1 | 37.0 ± 4.7 | 54.2 ± 8.1 |
| Inventive insecticide | 5.0 ± 0.0 | 8.6 ± 1.7 | 10.3 ± 3.5 | 12.9 ± 3.8 |
| treatment group | | | | |

As can be seen in Table 3 and FIG. 6, it was confirmed that the microbial insecticide of the present invention showed very excellent insecticidal effect against the thrips, compared to the Beauveria bassiana GHA strain known in the related art.

1. A microbial insecticide for control of thrips, comprising Beauveria bassiana ERL836 strain (KCCM11506P) or a spore thereof as an active ingredient.

2. The microbial insecticide of claim 1, wherein the thrips is Western flower thrips, Melon thrips, Frankliniella intonsa, or Thrips tabaci Lindeman.

3. The microbial insecticide of claim 1, which is in the form of solid granules.

4. The microbial insecticide of claim 3, which is in the form of the solid granules obtained by incubating the Beauveria bassiana ERL836 strain (KCCM11506P) in a solid culture medium selected from millet, white rice, wheat bran, Italian millet, sorghum, and a combination thereof.

5. The microbial insecticide of claim 3, which is applied to soil.

6. A method for control of thrips, comprising:
applying the microbial insecticide defined in claim 1 to an insect, a habitat thereof, a plant to be protected from the insect pest, or soil.

7. The method of claim 6, wherein the microbial insecticide is applied to the soil.
